(19) United States
(12) Patent Application Publication
(10) Pub. No.: US 2007/0240145 A1
(43) Pub. Date: Oct. 11, 2007

(54) Method and system for java application administration and deployment

(75) Inventors: Beena M. Saroj, Pleasanton, CA (US); Brian T. Selsor, Kimmswick, MO (US)

Correspondence Address: G. Michael Roebuck, PC, FROST BANK BUILDING, 6750 WEST LOOP SOUTH, SUITE 920, BELLAIRE, TX, 77401, US

(73) Assignee: SBC Knowledge Ventures L.P., Reno, NV (US)

(21) Appl. No.: 11/365,701

(22) Filed: Mar. 1, 2006

(51) Int. Cl. G06F 9/44

(52) U.S. Cl. 717/168

(57) ABSTRACT

In one embodiment a method is disclosed for deploying a java application including selecting the java application for deployment; reading a profile associated with the java application; selecting an environment based on the profile; and sending the java application to a application server associated with a user authorized for the environment. In another embodiment an automated system for deploying a java application includes a memory, a processor coupled to the memory, and a computer program stored in the memory. The computer program including instructions to select the java application for deployment, read a profile associated with the java application, select an environment based on the profile, and deploy the java application to an application server associated with a user authorized for the environment.

### BACKGROUND OF THE ILLUSTRATIVE EMBODIMENT

1. Field of the Illustrative Embodiment

This disclosure relates to the field computer program software applications deployment and administration.

2. Description of the Related Art

Computer software development, especially using a java specification enables thousands and thousands of permutations to accomplish application implementation and management. Deployment and production operations teams, responsible for installing various applications and upgrades must know and understand the nuances for all the permutations. The multiplicity of permutations also results in many manual steps, mistakes, and problems directly responsible for application instability and reduced availability of the applications during manual deployment.

### BRIEF DESCRIPTION OF THE DRAWINGS

For detailed understanding of the illustrative embodiment, references should be made to the following detailed description of an illustrative embodiment, taken in conjunction with the accompanying drawings, in which like elements have been given like numerals.

FIG. 1 is a flow chart depicting an illustrative embodiment showing a system for administration and deployment of software applications;

FIG. 2 is a flow chart depicting an illustrative embodiment of the algorithm for the application administration and deployment method (AAD tool);

FIG. 3 is a flow chart depicting another illustrative embodiment showing administration and deployment of software applications;

FIG. 4 is a flow chart depicting another illustrative embodiment showing administration and deployment of software applications; and

FIG. 5 is a diagrammatic representation of a machine in the form of a computer system within which a set of instructions, when executed, may cause the machine to perform any one or more of the methodologies of the illustrative embodiment.

### DETAILED DESCRIPTION OF AN ILLUSTRATIVE EMBODIMENT

In view of the above, an illustrative embodiment is presented through one or more of its various aspects to provide one or more advantages, such as those noted below.

In one aspect of a particular embodiment an automated method for deploying a java application is provided. The method includes selecting the java application for deployment, reading a profile associated with the java application, selecting an environment based on the profile and deploying the java application to an application server associated with a user authorized for the environment.

In another aspect of a particular embodiment the profile further includes at least one of the group consisting of environments, users, groups and other information necessary to effect said deployments.

In another aspect of a particular embodiment the method further includes disabling a target mapping in the java application during deployment thus allowing pre-deployment of applications by preventing them from becoming immediately active after deployment and enabling the target mapping in the computer program application after deployment to activate the java application.

In another aspect of a particular embodiment the method further includes preventing multiple users from the simultaneous deploying java applications within a java cluster.

In another aspect of a particular embodiment the method further includes automatically stopping and starting java applications.

In another aspect of a particular embodiment the method further includes sending a deployment status notification to a client device. In another aspect of a particular embodiment the notification is an email.

In another aspect of a particular embodiment the java application further includes at least one java component selected from the group consisting of EAR, WAR, SML, JSP, EJB, Property file, and Servlet.

In one aspect of a particular embodiment a computer readable medium containing instructions that when executed by a computer performs an automated method for deploying a java application. The method includes selecting the java application for deployment, reading a profile associated with the java application, selecting an environment based on the profile and deploying the java application to an application server associated with a user authorized for the environment.

In another aspect of a particular embodiment the profile further includes at least one of the group consisting of environments, users, groups and other information necessary to effect said deployments.

In another aspect of a particular embodiment the method further includes disabling a target mapping in the java application during deployment thus allowing pre-deployment of applications by preventing them from becoming immediately active after deployment and enabling the target mapping in the computer program application after deployment to activate the java application.

In another aspect of a particular embodiment the method further includes preventing multiple users from the simultaneous deploying java applications within a java cluster.

In another aspect of a particular embodiment the method further includes automatically stopping and starting java applications.

In another aspect of a particular embodiment the method further includes sending a deployment status notification to a client device. In another aspect of a particular embodiment the notification is an email.

In another aspect of a particular embodiment wherein in the method the java application further includes at least one java component selected from the group consisting of EAR, WAR, SML, JSP, EJB, Property file, and Servlet.

In one aspect of a particular embodiment an automated system for deploying a java application is provided. The system includes a memory, processor coupled to the memory, and a computer program stored in the memory. The computer program further includes instructions to select the java application for deployment, read a profile associated with the java application, select an environment based on the profile and deploy the java application to an application server associated with a user authorized for the environment.

In another aspect of a particular embodiment the profile further includes at least one of the group consisting of environments, users, groups and other information necessary to effect said deployments.

In another aspect of a particular embodiment the computer program further includes instructions to disable a target mapping in the java application during deployment thus allowing pre-deployment of applications by preventing them from becoming immediately active after deployment and enable the target mapping in the computer program application after deployment to activate the java application.

In another aspect of a particular embodiment the computer program further includes instructions to prevent multiple users from the simultaneous deploying java applications within a java cluster.

The illustrative embodiment provides a method and system for software application administration and deployment. In the illustrative embodiment, a method and system provide a java application running on a computer system. The illustrative method and system provide for software application deployments and administration of java applications, or java components including but not limited to WAR™ (Web Archive) files, EAR™ (Enterprise Archive) files, xml™ (Extended Mark Up Language) files, JSP™ (Java Server Pages) files, Servlets, EJB™ (Enterprise Java Beans), and Property (configuration) files. In one embodiment an IBM™ WebSphere™ system and environment can be provided as a contributing portion of the illustrative method and apparatus. The system and method are configurable and extensible to any application and make it easy to add new applications and environments. The illustrative method and system provide multiple methods of acquiring code files for deployments.

In an illustrative embodiment, the system and method enable the establishment of group identifiers (ids) based upon environment such that different groups of users operating in different environments are enable to execute and perform deployments and administrative functions on different environments (e.g. Development, Quality Control, System Test and Production). Application server administration and deployments can be performed by a single system and/or method.

A particular embodiment is extensible in that multiple methods of acquiring software applications or software modules, for example, Enterprise Archives (EARs,) are allowed for administration and deployment. Examples are local share drives, remote share drives, and source code repositories such as CVS™, or e.changeman™. The time taken by an illustrative embodiment to complete a software application deployment task is 90% less than the time taken for manual software application deployments and changes. Thus, the illustrative embodiment reduces manpower requirements and time spent in accomplishing the software application administration and deployment task.

In an illustrative embodiment, product administrators have authority to assign user ids and passwords and do not need root access. In an illustrative embodiment, the method and apparatus provide an application administration and deployment tool that provides methods to assign multiple user access levels. An administrator may access the method and apparatus via a browser or graphical user interface (GUI). Thus, a particular user may be authorized as a member or participant for more than one environment. The method and apparatus sends notifications including, but not limited to, email, voice mail, instant messaging or text messaging notifications of completion of deployments. Deployment results can be posted to a website for real time status remote viewing over the internet during and after software deployment and releases.

Manual deployment and administration of software applications are prone to errors and frequently create application downtime. By using the automatic functionality of the method and apparatus of an illustrative embodiment, superior software application deployment and work is delivered in less time than manual administration and deployment. This results in substantial savings for the enterprise. In addition, increased customer satisfaction leads to higher customer retention and revenue generation.

The illustrative embodiment standardizes, centralizes, and automates software application deployments in a highly flexible but standard manner and, in so doing, enforces conformance to a versatile model for implementation and management of application deployments. The end result is greater efficiency for all resources involved in the application development cycle, improved stability of production applications, improved operational management, standardization of development implementation approaches, and reduction in overall ambiguity inherent to the java specification.

The illustrative embodiment enables the assignment of groups and associated environments which help to reduce security issues which are also difficult to manage. Group and environment separation controls provided by an illustrative embodiment help to provide regulatory compliance (i.e., Sarbanes-Oxley considerations/requirements). This is especially important for larger corporations, large computer technology firms or any entity supporting multiple development teams and multiple environments. The separation of groups, users and environments helps keep users segregated by function so that security and Sarbane-Oxley type concerns are reduced.

The illustrative method and apparatus of the illustrative embodiment helps to provide group and user administration. In an illustrative embodiment, the method and apparatus assign groups of associated users or individual users to the environments; provides multiple user access levels so that a single user may have access in more than one environment; provide flexible enterprise archive (EAR™) (software application code) source locations; provide for remote administration, deployment and status monitoring over the internet; and provide a graphical user interface (GUI) to the method and apparatus for deployment and administration. An illustrative embodiment is operating systems (OS) independent; is configurable and extensible for any computer software application; makes it easy to add new applications and new environments; deploys enterprise java beans (EJB™) and web applications; deploys in clustered and non clustered environments; supports pre-deployment of applications; provides an immediate release status update web site; and provides notifications of release status via e-mail or via other communication modes.

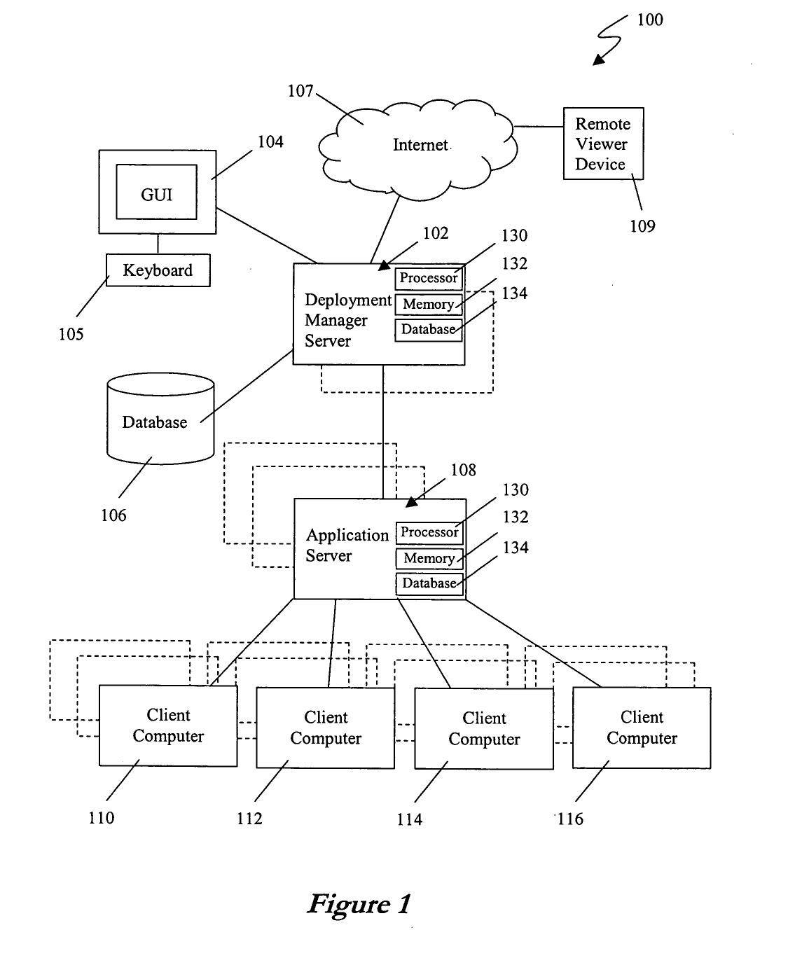

Turning now to FIG. 1, FIG. 1 is a diagram where a GUI at 104 accesses the Deployment Manager at 102. The Deployment Manager (DM) server 102 (also referred to as the DM destination server) accesses the enterprise database 106 or database 134 for an EAR (software application) and profile of installation instructions) and sends the data to the application server 108. The illustrative method is implemented on the DM server. The Application Server provides the application to and sends data to Client Computers 110, 112, 114, and 116. A remote user can access the GUI or review status over the internet 107. Each server 102 and 108 includes but is not limited to a processor 130, memory 132 couple to processor 130 and database 134. The processor is coupled to the memory and database. A computer readable medium embedded in the memory 132 may contain instructions that implement the methods described herein when executed by a processor. The memory 132 can include a computer program that is embedded in the memory 132 that can include logic instructions to perform one or more of the method steps described herein. Additionally the database 134, containing data structures for storing application software (EARS) and profiles, is coupled to the processor 130. The server can be a java machine such as a Sun Microsystems computer.

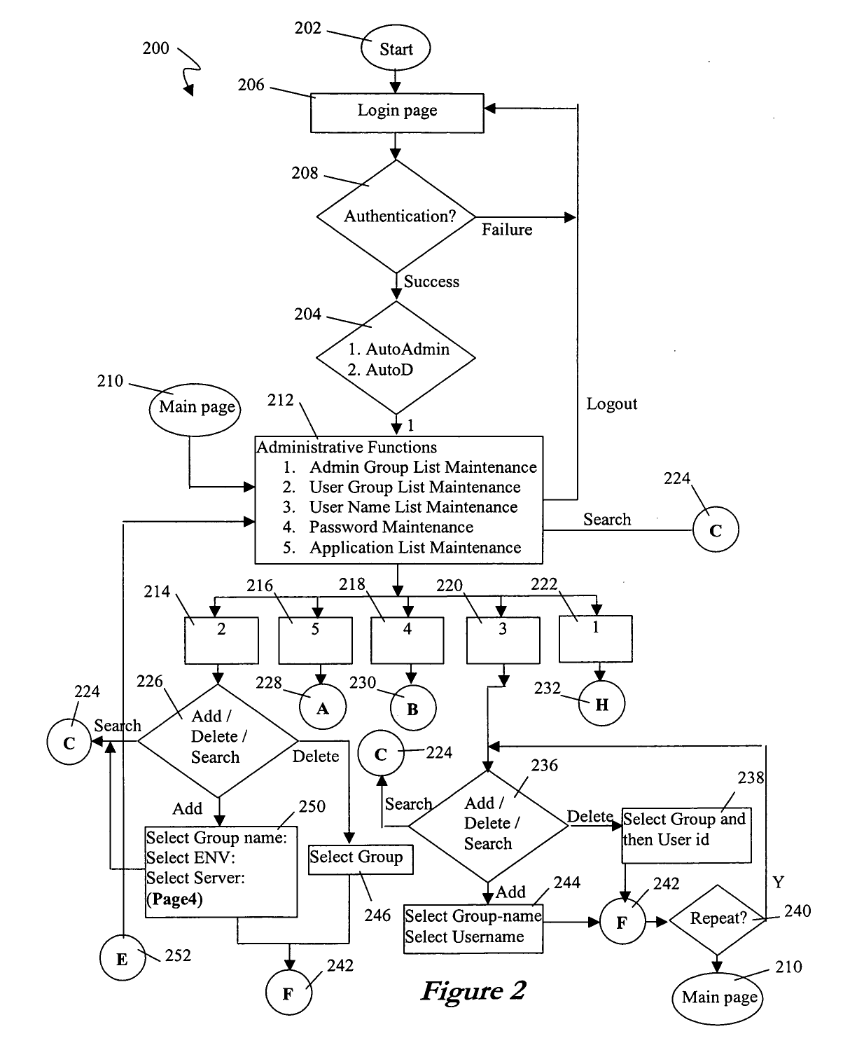

Turning now to FIG. 2, FIG. 2 is a flow chart 200 of functions performed in an illustrative embodiment. A shown in FIG. 2 the application begins at block 202. At 204 the option of AutoAdmin and Automatic Deployment (AutoD) screen data is presented on the GUI. At 206 the user is presented the Login screen data on the GUI display device 104. A user interacts with the data presented at the GUI display device by selection options present via the GUI and entering data from the keyboard 105 or a remote viewer and data entry device 109. A user logs in to using a user identifier and group or environment identifier. Authentication of user identifiers, environments and groups input by the user is performed at 208. If authentication fails at 208 the application returns to Login screen at 206. If authentication is successful at 208 the application continues to Administrative Functions GUI screen at 212. The Administrative Functions GUI screen at 212 presents the user the following selection options: 1) Admin Group List Maintenance, 2) User Group List Maintenance, 3) User Name List Maintenance, 4) Password Maintenance, and 5) Application List Maintenance. From 212 the user can go to 210 Main page, Logout and return to 206, or perform a search that will take the user to C at 224. The illustrative embodiment system and method only permits one user per cluster and thus locks out or prevents more than one user from simultaneous java applications in the same java cluster.

When the user chooses option 2 from the administrative functions GUI screen 212 the method proceeds to a GUI screen 226 and the user is given the options of Add/Delete/Search on the GUI screen. If the option Add is selected the user is taken to 250 to Select Group name, Select environment (ENV), and Select Server screen. If the option Delete is selected the user is taken to 246 to Select Group. If the option Search is selected the user is taken to C at 224.

When the user chooses option 5 216 from GUI screen 212 the method proceeds to A at 228. When the user chooses option 4 218 from GUI screen 212 the method proceeds to B 230. When the user chooses option 3 220 from GUI screen 212 the method proceeds to 236 and present the options of Add/Delete/Search GUI screen. If the option Add is selected the method proceeds to 244 to Select Group-name, and Select Username. If the option Delete is selected the user is taken to 238 to Select Group and then User id. If the option Search is selected the method proceeds to C at 234.

When the user chooses option 1 from GUI screen 212 the method proceeds to administration group maintenance screen at which a user can create or delete groups and environments and add or delete user members to and from the groups and environments.

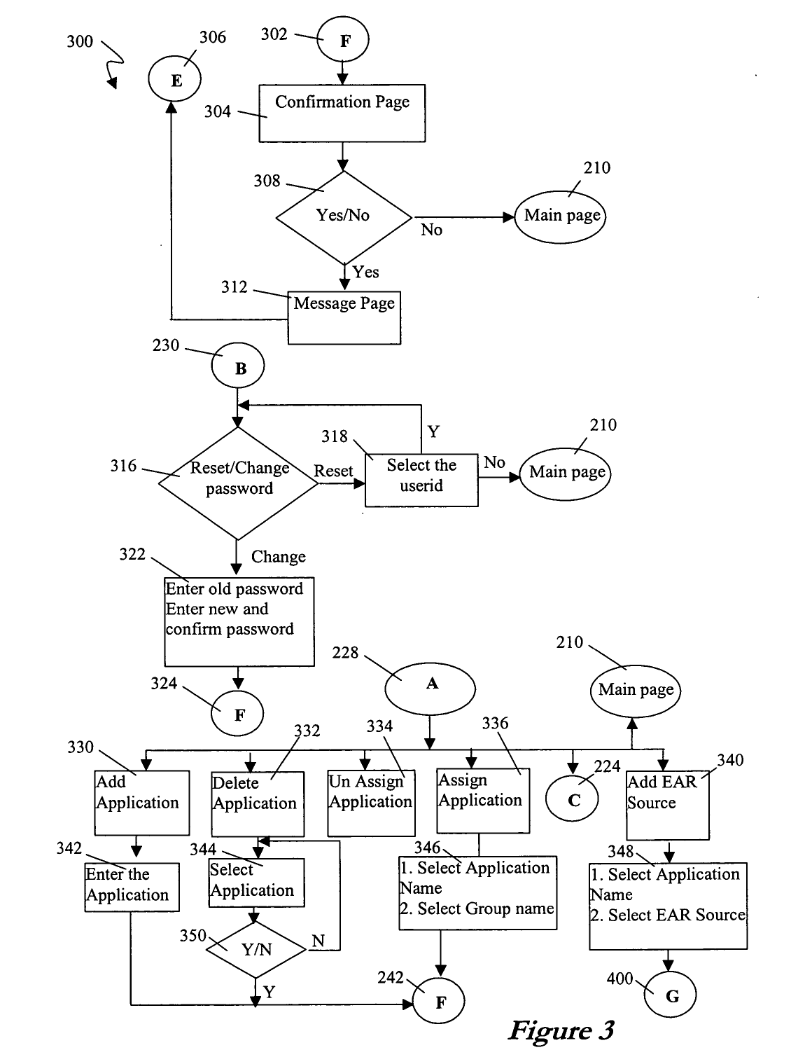

Turning now to FIG. 3, FIG. 3 begins with F at 302. At 304 the method proceeds to Confirmation Page screen 304 and then to 308 to answer Yes/No. If the user answers Yes they are taken to Message Page at 312 and on to E at 306. If the user answers No the method proceeds to the Main Page screen at 210.

The user begins password maintenance at B 230. The method proceeds to a Reset/Change password GUI screen at 316. If the user chooses Reset at the GUI screen 316, the method proceeds to 318 to select a user identifier (userid) at the GUI screen. When the user completes this step the method proceeds to B 230. If the user chooses Change password option on the GUI screen at 316 the method proceeds to 322 to select a GUI screen option from Enter old password, Enter new and confirm password and the method proceeds to F at 242.

The user begins application list maintenance at on an application list maintenance GUI screen A 228. The method may proceed to the Add Application screen 330, to 342 to Enter the Application and then to end at F at 242. From A 228 the method may proceed to 332 to Delete Application screen and to 344 to Select Application, to 350 to choose Yes/No. If the user chooses Y at 350 method proceeds to F at 242. If the user chooses N at 350 the method proceeds to 332. From A 228 the method may proceed to 334 to an Un-assign Application GUI screen. From A 228 the method may also proceed to 336 to an Assign Application GUI screen, then proceed to 346 to Select Application Name and Select Group name GUI screen and then to F at 242. From A 228 the method may proceed to C at 224. From A 228 the method may proceed to 340 to Add EAR Source GUI screen, then proceed to 348 to Select Application Name and Select EAR Source GUI screen and routed on to G at 400. From A 228 the user may also be routed to Main GUI screen 210.

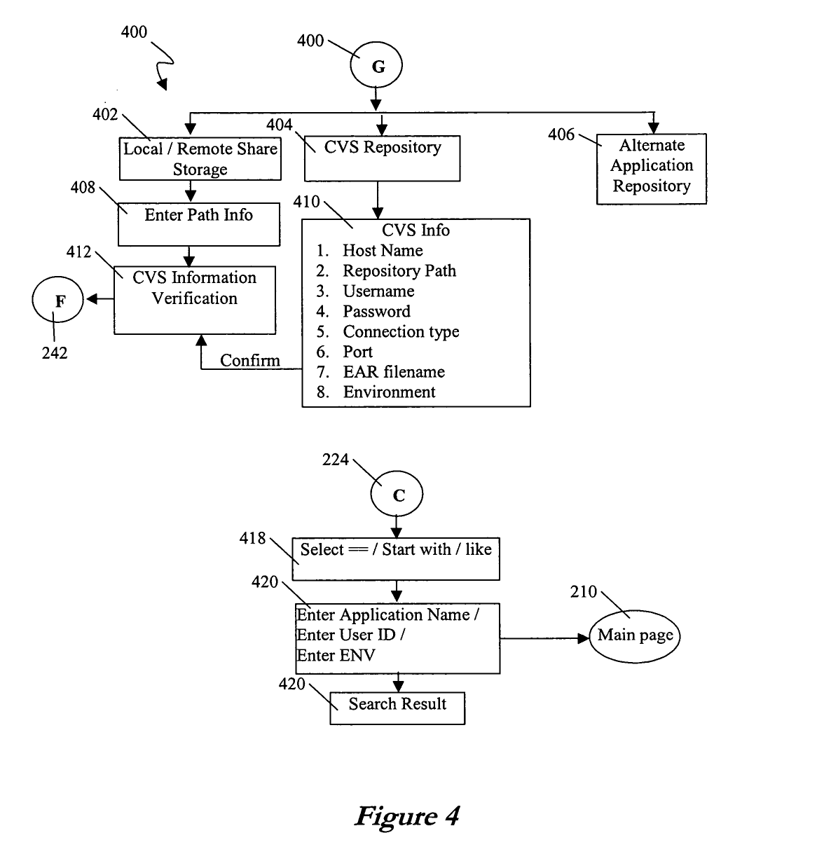

Turning now to FIG. 4, at 400 the user selection the source for the EAR. From G 400. From 400 the method proceeds to 402 Local/Remote Share screen, then to 408 Enter Path Info, then to 412 CVS Information Verification screen and then to F at 352. From 400 method may proceed to 404 CVS Repository screen, then to 410 CVS Info screen and then the user will confirm information and be routed to 412. CVS Info at 410 includes Host Name, Repository Path, Username, Password, Connection type, Port, EAR filename, and Environment. From 400 the user may also be routed to 406 alternate repository screen (“Changeman”).

From C 224 method proceeds to 418 Select=/Start with/like screen, then to 420 Enter Application Name/Enter User ID/Enter ENV, and then to 420 Search Result. From 420 the method proceeds to Main Page screen 210.

The following steps describe the internal process flow of illustrative method and system. After establishing and/or creating the profile data and storing it in a profile file for a java application or component, the illustrative system and method uses the profile data to dynamically construct the necessary instructions to administer or deploy the java application or component. The illustrative embodiment uses the profile to construct scripts that are sent to java ports. In the illustrative method and system, the Deployment Manager (DM) has been used as an example, but the system and method can be used with a destination Base Application Server (Non-Network Deployment scenario), as well. The illustrative system and method provides a third party API available from O'Reilly & Associates (http://www.servlets.com/cos/) to upload files from local PC to DM server 102. Step 1: User enters his user id & password to login. Step 2: User selects a Group. Step 3: User selects an Application for deployment. Step 4: User selects a Source for the software application, i.e., EAR file, ‘Local PC’; ‘DM Server’ OR ‘CVS Repository’. If a local PC is selected as the source for the EAR file, the file is uploaded to a folder having a path name, i.e., ‘/path/AAD/ear’. This file is deleted after successful installation of the application during the ‘clean-up’ operation. If an DM Server is selected the User enters a source location for the EAR folder & selects the EAR file. If a ‘CVS Repository’ is selected the User enters cvs repository details & EAR file. Step 5: User selects/enters following information & Starts the FTP process: Target Mapping; Class Loader Mode; WAR Classloader Policy; Uninstall and Name of the application to uninstall; Name of the application to install; WAS Admin Userid under which user identifier WebSphere products have been installed on the Destination DM server; WAS Admin Userid's password; UID for destination DM Server's FTP Server login; and Secure PASSCODE as password.

Target mapping indicates whether the application modules installed on the target server are started (or enabled) when the server starts. This sets the initial state of application modules. A true target mapping value indicates that the corresponding modules are enabled and thus are accessible when the server starts. A false target mapping value indicates that the corresponding modules are not enabled and thus are not accessible when the server starts. Thus, by disabling the target mapping, the software application (also referred to as application modules) can be pre deployed, that is, delivered in advance of activation. The software applications can be send days in advance with the target mapping disable. The modules can then be activated later by enabling the target mapping.

In an illustrative embodiment, during file transfer protocol, FTP transfer process, first the following three files are copied to ‘/path/’ folder on an application server 108, for example, an ‘[server name]’ server. The files are <APP_NAME>_<ENV_NAME>.properties from ‘/path/WEB/AAD’; Application's EAR file form ‘/path/AAD/ear’; and Clustered_Deployment.jacl or Non_Clustered_Deployment.jacl from ‘/path/WEB/AAD’. After successful FTP connection to the destination DM's FTP server, these files are copied to destination DM's ‘/tmp’ folder. Once the FTP operation is finished, the staged files are removed from the server after the deployment r.

Step 6: User starts the ‘TELNET’ process to the destination DM's TELNET server by entering his ‘USERID’ & ‘PASSWORD.

After successful login to destination DM's TELNET server, application deployment process starts executing the program script [e.g. wsadmin.sh]’ interface on the destination DM. The <APP_NAME>_<ENV_NAME>.properties file supplies the information such as Cluster or Non-Cluster installation, Cluster name, Node name, Application Server name & special properties such as Web module(s) to Virtual host mapping etc. The wsadmin.sh script reads Clustered_Deployment.jacl or Non_Clustered_Deployment.jacl, depending on the Cluster or Non-Cluster setting in the <APP_NAME>_<ENV_NAME>.properties file. If a user has selected to un-install an application, first the Cluster or Application server is issued a STOP command and then the application is un-installed. Next the application is installed in a Cluster or an Application Server depending on the setting in the <APP_NAME>_<ENV_NAME>.properties.

Application EAR file is installed at ‘APP_INSTALL_ROOT/cell_name’, e.g. $(APP_INSTALL_ROOT)/servernameNetwork/DefaultEAR.ear. After the successful installation of an application, application's ‘Target Mappings’ is ‘Enabled’ or ‘Disabled’ depending upon User's selection during the deployment. For Cluster deployments, after successful installation of an application, Cluster members are synchronized by issuing a Node Sync command. A Master configuration is then updated with a Save command.

The installation process is captured and stored in a log file, in the database under ‘<APP_NAME>_<ENV_NAME>_Deploy.log’ which is created in the ‘/tmp’ folder of the DM server. After the successful or un-successful deployment, this log file is copied to ‘[servername]’ server at location ‘/path/AAD/logs’. A status record is hen created and inserted into database at the DM server along with the log file; an HTML file with name ‘<APP_NAME><ENV_NAME>.html’ is created in the ‘/path/AAD/buildinfo’ folder in the data base at the DM server; and Status Mail gets prepared & sends to the recipients named in the ‘autod_config.properties’.

Step 7: User logouts from the DM server GUI or browser or selects to deploy another application.

In an illustrative embodiment, the url for internet access to the system and method is[HostName:]9083/newAdmin. 1) Stage the ear files on the server under (/path/AAD/xxxx-EAR/) with 777 file permissions. Where “xxxx” is the application name. 2) AIX™ OS pre-requisite: Login command prompt should be “>” (for example: AdminUserid@servername> or just “>”). 3) Make sure the Administrator Userid client is connected to the dmgr server process (If scripting client is not connected to a dmgr server process, change the default value of SOAP connector port from 8879 to 8889 in the wsadmin.properties file).

In an illustrative embodiment, the system and method is used for deployment of various java applications and components in multiple environments. The following steps are implemented during the deployment process. An application specific property file is created and used to dynamically create a script to provide automatic deployment (deployment includes transferring and installing the application) information; Stop the cluster; Uninstall the existing application; Save server configuration; Install a new application in a cluster or standalone server; Support Pre-deployment; Enable/disable target mapping; Setting Classloader Mode and WAR Classloader Policy; Save server configuration; Synchronize the cluster nodes; Update the build information webstat site; and Send email notification to respective application support members. The scripts can run automatically without a user input to a GUI.

The following screens are provided in an illustrative embodiment. Login screen User ID>xxx user id and Password>xxx (default password). The password can be changed anytime by clicking the Change Password next to the Password text box. An email notification is sent once the change is complete. Select Group screen A user can select group and click on Continue. (Group name reflects the Deployment manager host name/application server hostname together with the environment (e.g. Test, Development, Production etc) which are assigned using the AutoDAdmin screen. The users will be authorized to select only the group(s) and/or environments for which they have access).

Select Application screen. A user selects the application (use the text box with pull down arrow. Group Name will be populated.) and Click Continue.

Prepare for Deployment screen. The user selects java component (e.g. EAR) Location Local Path (radio button); Server Path (radio button); CVS Repository (radio button); Select ‘Local Path’ option to Select EAR from Local Machine File System; Select ‘Server Path’ option to select EAR from ‘Deployment Tool Server’ File System; Select ‘CVS Repository’ to get EAR file from project's CVS server; and Click Continue.

Prepare for Deployment continued screen. When Local Path is selected user selects an EAR file using the Browse button from Local Machine File System and Click Continue.

When Server Path is selected in a prepare for deployment screen, Select/Enter EAR path (using the browse button to select EAR path); Select EAR file (The EAR files staged in the above assigned path will be automatically populated. The user selects the browse button to select the EAR file) and clicks Continue.

When CVS Repository is selected, the user enters a Host name of a CVS server (e.g. Server/domain); Enter Repository Path (e.g. /cvs_prod/); Enter CVS User Name; Enter Password; enters EAR Folder (The folder name should not begin with “/” and should not contain any spaces in between (e.g. Application/EAR )); enters EAR file name; and clicks Continue.

Final Review screen The user enters the following information on the final review GUI screen: 1) Target Mappings: By default the check box is selected which enables the target mappings and is used for normal deployments. Applications may be deployed in advance (days if necessary) by disabling target mapping. For target mappings to be disabled during pre-deployment of applications the user unchecks the Target Mappings check box on the GUI screen. 2) Classloader Mode: Specifies whether the classloader searches in the parent classloader or in the application classloader first to load a class. The standard for JDK classloaders and WebSphere Application Server classloaders is PARENT_FIRST. By specifying PARENT_LAST, your application can override classes contained in the parent classloader, but this action can potentially result in ClassCastException or LinkageErrors if the user has mixed use of overridden classes and non-overridden classes. The options are PARENT_FIRST and PARENT_LAST. The default is to search in the parent classloader before searching in the application classloader to load a class.) Default: PARENT_FIRST.

3) WAR Classloader Policy: Specifies whether to use a single classloader to load all WAR files of this application or to use a different classloader for each WAR file. The options are APPLICATION and MODULE. The default is to use a separate classloader to load each WAR file. Default: MODULE. 4) To uninstall existing application the user selects the check box APP Name to UnInstall. The user enters the enterprise application name that needs to be uninstalled. 5) Skip step 4 if existing application is not uninstalled. Continue to step 5 and also make sure APP Name to UnInstall check box is unchecked. 6) The user enters the enterprise APP Name to Install. Administrator User Id and Password are the admin user name/password which are used for executing the wsadmin scripts (User id under which the WebSphere products have been installed on the destination/remote DM server); Ftp User Id is server logon id; Ftp Password is logon password; Verify the above details; and Click FTP Transfer button.

Install Application screen: Note: Depending upon authentication method, users may enter a Secure code from SecureID™ cards. Telnet user id is user id; Telnet Password is logon password; and Click Deploy button. After the deployment is complete the user can either logout from AutoD Tool or select to deploy another application.

The following is the list of settings to be present on WebSphere DMs running on WINDOWS platforms. 1) FTP Server running on port 21/tcp; 2) “Directory Listing Style” of the FTP Server should be of “UNIX” type. In case of Default Windows “IIS FTP Publishing Service” based FTP Server, Right Click on FTP Server→Properties→Home Directory tab→Directory Listing Style. 3) FTP Server should have one “virtual directory” defined as “C:”; 4) There should be “tmp” folder present on c: drive; 5) Local FTP users, who should be member of local server's “Administrators” group; 6) Multiple User access TELNET Server running on port 23/tcp and NOT the default one coming with WINDOWS; and 7) Local TELNET users, who should be member of local server's “Administrators” group.

These instructions are applicable for installing the illustrative method and apparatus on WebSphere Application Server (ND/Base Version) running on AIX (i.e. UNIX) platform, ONLY. The method and apparatus can be installed on any platform and is not limited to UNIX. The installable & configuration files of this tool are located in CVS repository mentioned above in folders Config, Database, Docs & EARs. The method and system stores all the configuration data in relational database. Oracle9i has been used and tested satisfactorily. Install Oracle9i server & create the tables, indexes & constraints under some schema owner (e.g. ADT).

The user inserts one row into “ADMIN” table. One of the components provided in the illustrative embodiment is based on ANT technology (a Java based build tool from Apache). The illustrative system and method has been tested with “Apache ANT version 1.6.0”. Install the Apache ANT version 1.6.0 & make sure that ANT environment is available to the system-id under which “WebSphere products” have been installed.

Installation & Configuration—1) Install the .EAR file of the illustrative system and method on WebSphere Application Server (Cluster/Member Server of Network Deployment/Standalone). 2) Create following folders under /path/AAD in AAD Tool installed box: ear, buildinfo, staging, and logs. Change mode to 777 for all directories. 3) Place the following files under /path/AAD directory: Clustered_Deployment.jacl; Non_Clustered_Deployment.jacl; build.xml; build.properties; autod_config.properties; and Oracle JDBC Driver, classes12.zip. Change mode to 644 for all files. 4) Edit autod_config.properties to change the following variable values. Many of the parameters in this file have fixed values. Those should not be altered.

The following parameters are dynamic and can be set to their values as per the environment where illustrative embodiment of system and method has been installed. 1) Enter the directory location of installed AAD Tool web modules in the WebSphere Application Server (buildinfo.dm.path=/WAS_home path/installedApps/[server network name]). 2) Enter email addresses of persons (separated by “,”) to receive notification of every deployment done (mail.to.list=[userid @[mailserver domain], ). 3) Enter hostname of SMTP server for sending emails (e.g. mail.host=userid/domain). 4) Enter the “body” message to be sent in email (mail.content=Please see attached $ {app} $ {env} Deployment process log). 5) Enter the “Subject” of the mail (mail.subject=${app} ${env} Deployment Automatic Notification). 6) Enter the “FTP server name” installed on the AIX™ Server where illustrative system and methods are installed. Usually this is the hostname of AIX™ server where FTP server is installed (adminserver=fully qualified server name (eg: server/domain)). 7) Enter a FTP Userid (remoteadmuser=xxxxx (e.g. webs_admin). (This should be a static userid & not an individual person's ftp userid.) 8) Enter password of the above-mentioned FTP User id (remoteadmpwd=yyyyy).

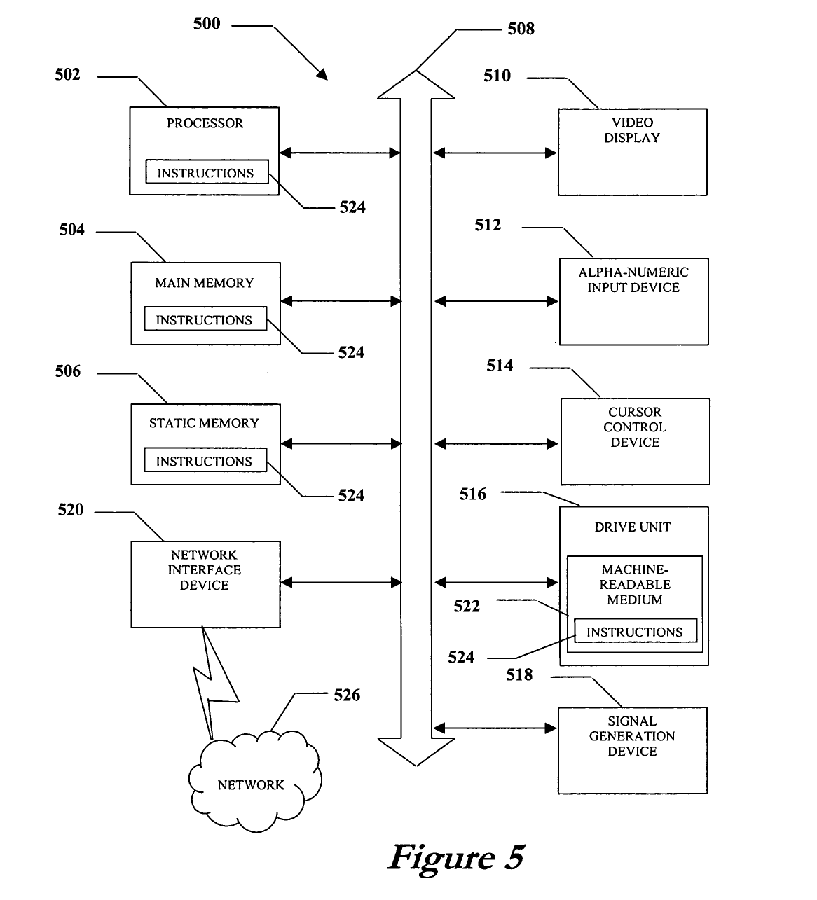

Turning now to FIG. 5 the computer system 500 may include a processor 502 (e.g., a central processing unit (CPU), a graphics processing unit (GPU), or both), a main memory 504 and a static memory 506, which communicate with each other via a bus 508. The computer system 500 may further include a video display unit 510 (e.g., liquid crystals display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated in herein above. The instructions 524 may also reside, completely or at least partially, within the main memory 504, the static memory 506, and/or within the processor 502 during execution thereof by the computer system 500. The main memory 504 and the processor 502 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the illustrative embodiment, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The illustrative embodiment contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the illustrative embodiment. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the illustrative embodiment is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the illustrative embodiment is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

1. An automated method for deploying a java application comprising:
selecting the java application for deployment;
reading a profile associated with the java application;
selecting an environment based on the profile; and
deploying the java application to an application server associated with a user authorized for the environment.

2. The method of claim 1 wherein the profile further comprises at least one of the group consisting of environments, users, groups and other information necessary to effect said deployments.

3. The automated method of claim 1, the method further comprising:
disabling a target mapping in the java application during deployment thus allowing pre-deployment of applications by preventing them from becoming immediately active after deployment; and
enabling the target mapping in the computer program application after deployment to activate the java application.

4. The method of claim 1, the method further comprising:
preventing multiple users from the simultaneous deployment of java applications within a java cluster.

5. The method of claim 1, the method further comprising:
automatically stopping and starting java applications without use of so called administrative consoles, gui's or scripts.

6. The method of claim 1, further comprising:
sending a deployment status notification to a client device.

7. The method of claim 1, wherein the notification is an email.

8. The method of claim 1 wherein the java application further comprises at least one java component selected from the group consisting of EAR, WAR, XML, JSP, EJB, Property file, and Servlet.

9. A computer readable medium containing instructions that when executed by a computer performs an automated method for deploying a java application, the method comprising:
selecting the java application for deployment;
reading a profile associated with the java application;
selecting an environment based on the profile; and
deploying the java application to an application server associated with a user authorized for the environment.

10. The method of claim 9 wherein the profile further comprises at least one of the group consisting of environments, users, groups and other information necessary to effect said deployments.

11. The medium of claim 9, the method further comprising:
disabling a target mapping in the java application during deployment thus allowing pre-deployment of applications by preventing them from becoming immediately active after deployment; and
enabling the target mapping in the computer program application after deployment to activate the java application.

12. The medium of claim 9, the method further comprising:
preventing multiple users from the simultaneous deployment of java applications within a java cluster.

13. The medium of claim 9, the method further comprising:
automatically stopping and starting java applications without use of so called administrative consoles, gui's or scripts.

14. The medium of claim 9, the method further comprising:
sending a deployment status notification to a client device.

15. The medium of claim 9, wherein in the method the notification is an email.

16. The medium of claim 9 wherein in the method the java application further comprises at least one java component selected from the group consisting of EAR, WAR, XML, JSP, EJB, Property file, and Servlet.

17. An automated system for deploying a java application comprising:
a memory;
a processor coupled to the memory; and
a computer program stored in the memory;
the computer program comprising instructions to:
select the java application for deployment,
read a profile associated with the java application,
select an environment based on the profile, and
deploy the java application to an application server associated with a user authorized for the environment.

18. The system of claim 17 wherein the profile further comprises at least one of the group consisting of environments, users, groups and other information necessary to effect said deployments.

19. The automated system of claim 17, the computer program further comprising instructions to:
disable a target mapping in the java application during deployment thus allowing pre-deployment of applications by preventing them from becoming immediately active after deployment, and
enable the target mapping in the computer program application after deployment to activate the java application.

20. The system of claim 17, the computer program further comprising instructions to:
prevent multiple users from the simultaneous deployment of java applications within a java cluster.
